(19) United States
(12) Patent Application Publication
(10) Pub. No.: US 2022/0374738 A1
(43) Pub. Date: Nov. 24, 2022

(54) Failure Prediction Device, Learning Device, and Learning Method

(71) Applicant: Mitsubishi Electric Corporation, Tokyo (JP)

(72) Inventors: Yasuhiko WADA, Tokyo (JP); Kazunori SAKANOBE, Tokyo (JP); Kenta YUASA, Tokyo (JP)

(21) Appl. No.: 17/634,479

(22) PCT Filed: Nov. 12, 2019
(86) PCT No.: PCT/JP2019/044418

§ 371 Date: Feb. 10, 2022

(51) Int. Cl. G06N 5/04; G06N 5/02

(52) U.S. Cl. CPC G06N 5/04; G06N 5/022

(57) ABSTRACT

A failure prediction device that predicts a failure of a bearing of a compressor mounted on an air-conditioner, the failure prediction device including an observation unit that acquires, as state variables, a first state variable indicating a state of a motor and a second state variable indicating a state of an electrical device, a conversion unit that converts the state variables into a frequency domain, a generation unit that generates failure information on a failure of the bearing using frequency characteristics of the state variables obtained by converting the state variables into the frequency domain by the conversion unit and a learned model representing a relationship between the frequency characteristics of the state variables and model failure information on the failure of the bearing, and an output unit based on the failure information generated by the generation unit.

### CROSS REFERENCE TO RELATED APPLICATION

This application is a U.S. national stage application of International Patent Application No. PCT/JP2019/044418 filed on Nov. 12, 2019, the disclosure of which is incorporated herein by reference.

### TECHNICAL FIELD

The present disclosure relates to a failure prediction device, a learning device, and a learning method.

### BACKGROUND

A prediction device that predicts a failure of a bearing of a spindle of a motor has been proposed. For example, PTL 1 discloses a learning device that executes machine learning to predict a failure of a bearing.

### PATENT LITERATURE

PTL 1: U.S. Pat. No. 6,140,331

According to the invention disclosed in PTL 1, information optimal for prediction of a failure of a bearing is not used. This causes the invention disclosed in PTL 1 to fail to increase accuracy of prediction of the failure of the bearing.

### SUMMARY

The present disclosure has been made to solve the above-described problems, and it is therefore an object of one aspect to provide a technique for allowing an increase in accuracy of prediction of a failure of a bearing.

According to one aspect of the present disclosure, provided is a failure prediction device that predicts a failure of a bearing of a motor mounted on an electrical device, the failure prediction device including a variable acquisition unit, a conversion unit, a generation unit, and an output unit. The variable acquisition unit acquires, as a state variable, at least one of a first state variable indicating a state of the motor and a second state variable indicating a state of the electrical device. The conversion unit converts the state variable into a frequency domain. The generation unit generates failure information on a failure of the bearing using frequency characteristics of the state variable obtained by converting the state variable into the frequency domain by the conversion unit and a model representing a relationship between the frequency characteristics of the state variable and model failure information on the failure of the bearing. The output unit outputs the failure information generated by the generation unit.

According to another aspect of the present disclosure, provided is a learning device for optimizing an inference model to be used for predicting a failure of a bearing of a motor mounted on an electrical device, the learning device including a data acquisition unit, an extraction unit, and a learning unit. A data acquisition unit acquires a training dataset including frequency characteristics of a state variable obtained by converting the state variable into a frequency domain, the state variable being at least one of a first state variable indicating a state of the motor and a second state variable indicating a state of the electrical device, and a plurality of pieces of training data in which the frequency characteristics are labeled with failure information on a failure of the bearing. The extraction unit extracts the frequency characteristics from the training dataset. The learning unit optimizes the inference model so as to make an inference result that is output from the inference model by inputting the frequency characteristics extracted from the training dataset to the inference model as close as possible to the failure information with which the training dataset is labeled.

According to the present disclosure, a failure of a bearing of a spindle of a motor is predicted using the frequency characteristics of the state variable converted into the frequency domain. This allows the present disclosure to increase accuracy of prediction of the failure of the bearing.

### BRIEF DESCRIPTION OF DRAWINGS

FIG. 1 is a diagram for describing an example of a configuration of a learning system according to the present embodiment.

FIG. 2 is a diagram for describing an inside of a compressor.

FIG. 3 is a diagram for describing an example of a hardware configuration of a learning device according to the present embodiment.

FIG. 4 is a diagram for describing a case where a spindle and a main bearing are in a normal lubrication state.

FIG. 5 is a diagram for describing a case where the spindle and the main bearing are in an abnormal lubrication state.

FIG. 6 is a diagram for describing a failure mode.

FIG. 7 is a diagram for describing frequency characteristics.

FIG. 8 is a diagram for describing an example of how to generate training dataset.

FIG. 9 is a diagram for describing details of processing performed by an extraction unit and a learning unit.

FIG. 10 is a diagram schematically describing an example of a configuration of an inference model 1400.

FIG. 11 is an example of a flowchart of the learning device.

FIG. 12 is a diagram for describing an example of a configuration of a failure prediction system according to the present embodiment.

FIG. 13 is a diagram for describing an example of a first table.

FIG. 14 is a diagram for describing a first modification of failure information.

FIG. 15 is a diagram for describing a second modification of the failure information.

FIG. 16 is a diagram for describing an example of a second table.

FIG. 17 is a diagram for describing an example of a third table.

FIG. 18 is a diagram for describing an example of how to display a replacement time.

FIG. 19 is a diagram for describing an example of a hardware configuration of a failure prediction device.

FIG. 20 is a diagram for describing processing performed by a generation unit.

FIG. 21 is an example of a flowchart of the failure prediction device.

FIG. 22 is a diagram for describing a learning system according to a third embodiment.

FIG. 23 is a diagram for describing a failure prediction system according to a fourth embodiment.

### DETAILED DESCRIPTION

Hereinafter, a failure prediction device, a learning device, and the like according to the present embodiment will be described with reference to the drawings and the like. In each drawing, components denoted by the same reference numerals are the same as or correspond to each other, and the same applies to all the following description of the embodiments. The forms of the components described herein are merely examples, and the present disclosure is not limited to the forms described herein. In particular, combinations of the components are not limited to combinations according to each embodiment, and a component described in one embodiment may be applied to another embodiment.

### First Embodiment

[Example of Configuration of Learning System]

A failure prediction device according to the present embodiment predicts a failure of a bearing using so-called artificial intelligence (AI). In a first embodiment, learning processing will be described prior to giving a description of prediction of a failure of a bearing. This learning processing is performed to generate an inference model used for predicting a failure of a bearing of a motor. Further, in a second embodiment to be described later, a failure prediction device will be described.

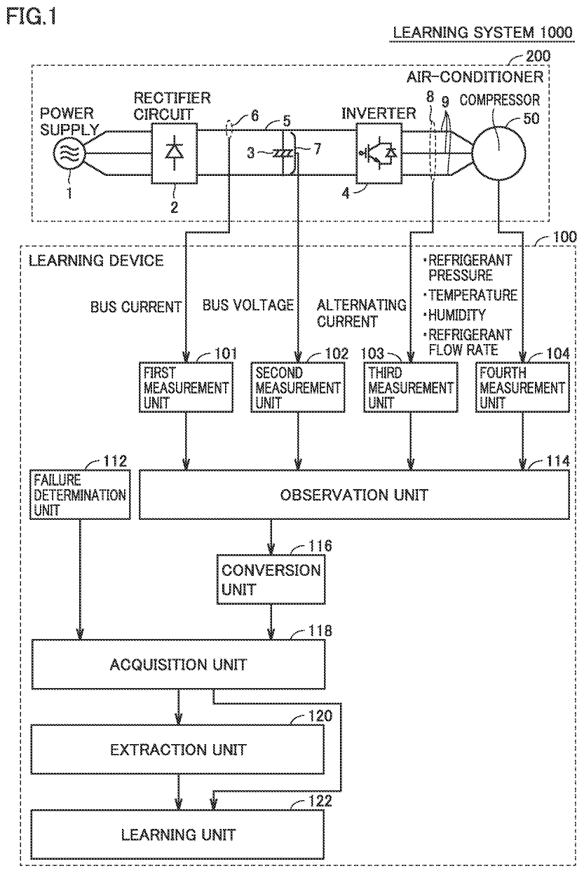

FIG. 1 is a diagram illustrating an example of a configuration of a learning system 1000 according to the present embodiment. Learning system 1000 includes a learning device 100 and an air-conditioner 200. Air-conditioner 200 includes a compressor 50. Learning system 1000 according to the present embodiment is to generate an inference model used for predicting a failure of a bearing of compressor 50. Although not clearly illustrated in FIG. 1, air-conditioner 200 includes compressor 50, a heat exchanger (not illustrated), and a fan (not clearly illustrated) that applies wind to the heat exchanger to implement a so-called air-conditioning cycle. FIG. 1 illustrates an example where learning device 100 and air-conditioner 200 are integrated into a single device.

First, air-conditioner 200 will be described. Air-conditioner 200 includes an AC power supply 1, a rectifier circuit 2, an electrolytic capacitor 3, an inverter 4, a bus 5, a bus current sensor 6, a bus voltage sensor 7, a current sensor 8, a three-phase power line 9, and compressor 50.

Rectifier circuit 2 converts three-phase (for example, UVW-phase) AC power output from AC power supply 1 into DC power. Electrolytic capacitor 3 smooths the DC power output from rectifier circuit 2. Compressor 50 is connected to inverter 4.

Inverter 4 outputs AC power to compressor 50 over bus 5. Typically, inverter 4 converts the DC power output from rectifier circuit 2 into AC power and outputs the three-phase AC power to compressor 50 over three-phase power line 9. Compressor 50 is driven by the three-phase AC power.

Bus current sensor 6 detects a current flowing through bus 5 (hereinafter, referred to as a “bus current”). In other words, bus current sensor 6 detects the bus current obtained as a result of the conversion made by rectifier circuit 2. Bus voltage sensor 7 detects a voltage of bus 5 (hereinafter, referred to as a “bus voltage”). In other words, bus voltage sensor 7 detects the bus voltage obtained as a result of the conversion made by rectifier circuit 2. Current sensor 8 detects a three-phase alternating current output to compressor 50 (hereinafter, referred to as an “alternating current”).

Next, a description will be given of learning device 100. Learning device 100 includes, as function modules, a first measurement unit 101, a second measurement unit 102, a third measurement unit 103, a fourth measurement unit 104, a failure determination unit 112, an observation unit 114, a conversion unit 116, an acquisition unit 118, an extraction unit 120, and a learning unit 122.

First measurement unit 101 measures the bus current detected by bus current sensor 6. First measurement unit 101 outputs the bus current thus measured to observation unit 114 as time-series data. Here, the “time-series data” refers to data output at predetermined intervals (for example, every 0.1 seconds). Second measurement unit 102 measures the bus voltage detected by bus voltage sensor 7. Second measurement unit 102 outputs the bus voltage thus measured to observation unit 114 as time-series data. Third measurement unit 103 measures the alternating current detected by current sensor 8. Third measurement unit 103 outputs the alternating current thus measured to observation unit 114 as time-series data.

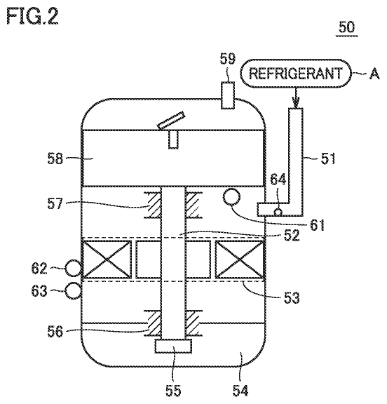

The bus current, the bus voltage, and the alternating current are variables indicating the state of motor 53 (see FIG. 2) included in compressor 50. The bus current, the bus voltage, and the alternating current are also referred to as a “first state variable”.

Fourth measurement unit 104 measures a pressure of a refrigerant in compressor 50, a temperature around compressor 50, humidity around compressor 50, and a flow rate of the refrigerant. The “pressure of a refrigerant in compressor 50” is referred to as a “refrigerant pressure”. The “temperature around compressor 50” is referred to as a “temperature of compressor 50”. The “humidity around compressor 50” is referred to as “humidity of compressor 50”. The “flow rate of the refrigerant” is referred to as a “refrigerant flow rate”. The refrigerant pressure, the temperature, the humidity, and the refrigerant pressure are information indicating an operation state of air-conditioner 200. Fourth measurement unit 104 outputs the refrigerant pressure, the temperature, the humidity, and the refrigerant flow rate as time-series data. The refrigerant pressure, the temperature, the humidity, and the refrigerant pressure are also referred to as a “second state variable” or “variable indicating the operation state of air-conditioner 200”. The first state variable and the second state variable are also collectively referred to as a “state variable”. That is, the “state variable” includes seven variables of “bus current, bus voltage, alternating current, refrigerant pressure, temperature, humidity, and refrigerant flow rate”. The “state variable” may be expressed as a “parameter” or a “feature”.

Further, first measurement unit 101, second measurement unit 102, third measurement unit 103, and fourth measurement unit 104 are collectively referred to as a “measurement unit”. According to the present embodiment, the seven variables of “bus current, bus voltage, alternating current, refrigerant pressure, temperature, humidity, and refrigerant flow rate” measured by the measurement unit correspond to the “state variable”.

Observation unit 114 observes the seven variables to acquire the seven variables. Observation unit 114 corresponds to a “variable acquisition unit” according to the present disclosure. The seven variables acquired by observation unit 114 are input to conversion unit 116. Conversion unit 116 converts each of the seven variables into a frequency domain. Conversion unit 116 converts each of the seven variables into the frequency domain by, for example, the Fourier transform or fast Fourier transform. Note that conversion unit 116 may convert each of the seven variables into the frequency domain by another method. Frequency characteristics of the state variable converted into the frequency domain by conversion unit 116 are output to acquisition unit 118.

Failure determination unit 112 determines a failure of a bearing of compressor 50 using, for example, a predetermined method. Failure determination unit 112 generates failure information separately from failure information generated by a failure prediction device to be described in the second embodiment. The failure information is information indicating at least one of the followings: the presence or absence of the failure of the bearing in compressor 50, a degree of the failure of the bearing, and a type of the failure of the bearing.

Further, failure determination unit 112 may reproduce a failure state of compressor 50 in a simulation environment where the failure prediction device to be described in the second embodiment is simulated and generate the failure information based on the failure state. Further, failure determination unit 112 may generate the failure information in response to an input operation made by a user who has recognized the failure. The failure information generated by failure determination unit 112 is input to acquisition unit 118.

Acquisition unit 118 acquires a training dataset including the frequency characteristics of the state variable obtained by converting the state variable indicating the state of the motor into the frequency domain and a plurality of pieces of training data in which the frequency characteristics are labeled with the failure information on the failure of the bearing. Acquisition unit 118 corresponds to a “data acquisition unit” according to the present disclosure. Further, extraction unit 120 extracts the frequency characteristics from the training dataset. Learning unit 122 optimizes an inference model so as to make an inference result that is output from the inference model by inputting the frequency characteristics extracted from the training dataset to the inference model as close as possible to the failure information with which the training dataset is labeled. Note that details of processing performed by acquisition unit 118, extraction unit 120, and learning unit 122 will be described later.

[About Compressor]

FIG. 2 is a diagram illustrating an inside of compressor 50. FIG. 2 is a cross-sectional view taken along a direction in which a spindle 52 of compressor 50 extends. Referring to FIG. 2, compressor 50 according to the present embodiment will be described. Compressor 50 illustrated in FIG. 2 includes an intake pipe 51, spindle 52, a motor 53, lubricating oil 54, an oil pump 55, a sub bearing 56, a main bearing 57, a compression mechanism 58, and a discharge pipe 59. Compressor 50 that is a component of air-conditioner 200 causes a refrigerant to flow through a pipe to form a refrigeration cycle. Learning device 100 according to the present embodiment generates an inference model used for predicting a failure of main bearing 57. Note that, as a modification, learning device 100 may generate an inference model used for predicting failures of main bearing 57 and sub bearing 56. Further, learning device 100 may generate an inference model used for predicting a failure of sub bearing 56.

A low-temperature and low-pressure refrigerant A is drawn into compressor 50 through intake pipe 51. Further, motor 53 is, for example, directly or indirectly connected to three-phase power line 9 (see FIG. 1). Motor 53 is driven by AC power output from inverter 4 over three-phase power line 9. Spindle 52 is connected to motor 53. Motor 53 is driven to rotate spindle 52. Rotational energy of spindle 52 is transmitted to compression mechanism 58.

Lubricating oil 54 is stored in a bottom of compressor 50. Lubricating oil 54 is supplied to sub bearing 56 by oil pump 55. Lubricating oil 54 thus supplied lubricates sub bearing 56 and spindle 52. Further, lubricating oil 54 is supplied to main bearing 57 by oil pump 55. Lubricating oil 54 thus supplied lubricates main bearing 57 and spindle 52. Discharge pipe 59 causes refrigerant A compressed by compression mechanism 58 to become high in temperature and pressure to flow out of compressor 50.

Further, according to the present embodiment, a first sensor 61, a second sensor 62, a third sensor 63, and a fourth sensor 64 are installed in compressor 50. First sensor 61 detects the pressure of refrigerant A. Second sensor 62 detects the temperature around compressor 50. Third sensor 63 detects the humidity around compressor 50. Fourth sensor 64 measures the flow rate of refrigerant A flowing into compressor 50. According to the present embodiment, the flow rate indicates the amount of refrigerant flowing into compressor 50 per unit time (for example, every 1 second).

The pressure of refrigerant A detected by first sensor 61 (that is, the refrigerant pressure illustrated in FIG. 1) is output to fourth measurement unit 104. The temperature around compressor 50 detected by second sensor 62 (that is, the temperature illustrated in FIG. 1) is output to fourth measurement unit 104. The humidity around compressor 50 detected by third sensor 63 (that is, the humidity illustrated in FIG. 1) is output to fourth measurement unit 104. The flow rate of refrigerant A detected by fourth sensor 64 (that is, the refrigerant flow rate illustrated in FIG. 1) is output to fourth measurement unit 104.

[Example of Hardware Configuration of Learning Device 100]

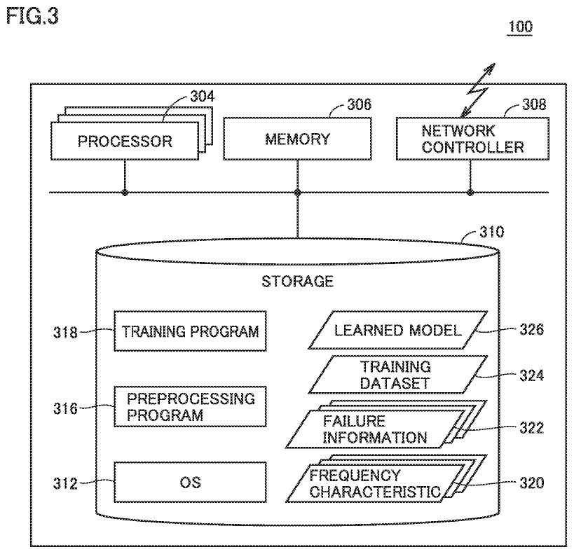

FIG. 3 is a diagram schematically illustrating an example of a hardware configuration of learning device 100 according to the present embodiment. Referring to FIG. 3, learning device 100 includes, as core hardware components, a processor 304, a memory 306, a network controller 308, and a storage 310.

Processor 304 is a computing entity that executes various programs to perform processing necessary for learning device 100 to work. Processor 304 includes, for example, at least either one or more CPUs or one or more GPUs. At least either a CPU or a GPU, each having a plurality of cores, may be used as processor 304. For learning device 100, it is preferable that a GPU or the like suitable for learning processing be adopted for generating a learned model.

Memory 306 provides a storage area for temporarily storing program code, a work memory, or the like when processor 304 executes a program. Examples of memory 306 may include a volatile memory device such as a dynamic random access memory (DRAM) or a static random access memory (SRAM).

According to the present embodiment, network controller 308 transmits and receives data to and from air-conditioner 200 and the like. Further, network controller 308 may transmit and receive data to and from other devices. Network controller 308 may adhere to any communication system such as Ethernet (registered trademark), a wireless local area network (LAN), and Bluetooth (registered trademark).

Storage 310 stores an OS 312 to be executed by processor 304, a preprocessing program 316 for generating a training dataset 324 to be described later, a training program for generating a learned model 326 using training dataset 324, and the like.

Frequency characteristics 320 correspond to the information obtained by converting the state variable into the frequency domain by conversion unit 116 (see FIG. 1). Frequency characteristics 320 correspond to the information transmitted from conversion unit 116 to acquisition unit 118. Failure information 322 correspond to the information generated by failure determination unit 112 (see FIG. 1). Failure information 322 correspond to the information transmitted from failure determination unit 112 to acquisition unit 118.

Training dataset 324 corresponds to a training dataset obtained by labeling (or tagging) frequency characteristics 320 with failure information 322. Learned model 326 is obtained as a result of learning processing performed using training dataset 324.

Examples of storage 310 include a non-volatile memory device such as a hard disk or a solid state drive (SSD).

Some of the libraries or functional modules necessary for processor 304 to execute preprocessing program 316 and training program 318 may be implemented using standard libraries or functional modules provided by OS 312. In this case, neither preprocessing program 316 nor training program 318 includes all program modules necessary for implementing a corresponding function, but preprocessing program 316 and training program 318 are installed in the runtime environment of OS 312 so as to allow a functional configuration according to the present embodiment to be implemented. This allows even such a program that lacks some libraries or functional modules to fall within the technical scope of the present embodiment.

Preprocessing program 316 and training program 318 may be distributed with preprocessing program 316 and training program 318 stored in a non-transitory recording medium such as an optical recording medium such as an optical disc, a semiconductor recording medium such as a flash memory, a magnetic recording medium such as a hard disk or a storage tape, or a magneto-optical recording medium such as an MO and installed in storage 310. Therefore, training program 318 according to the present embodiment may correspond to a program installed in storage 310 or the like, or a recording medium storing a program for implementing a function or processing according to the present embodiment.

Further, the program for implementing learning device 100 may be distributed not only with the program stored in any desired recording medium as described above but also through download from a server device or the like over the Internet or an intranet.

FIG. 3 illustrates an example of a configuration where a general-purpose computer (processor 304) executes preprocessing program 316 and training program 318 to implement learning device 100. Note that all or some functions necessary for implementing learning device 100 may be implemented via a hardwired circuit such as an integrated circuit. For example, such functions may be implemented via an application specific integrated circuit (ASIC), a field-programmable gate array (FPGA), or the like.

[About Failure of Main Bearing]

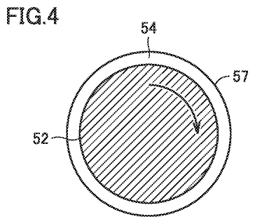

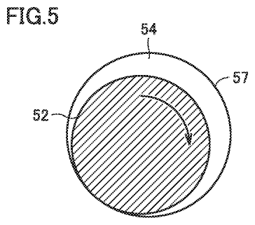

Next, a description will be given of a failure of main bearing 57. FIGS. 4 and 5 are diagrams for describing the failure of main bearing 57. FIGS. 4 and 5 are cross-sectional views of spindle 52 and main bearing 57 taken along a plane orthogonal to the direction in which spindle 52 extends. FIG. 4 is a diagram for describing a case where spindle 52 and main bearing 57 are in a normal lubrication state. FIG. 5 is a diagram for describing a case where spindle 52 and main bearing 57 are in an abnormal lubrication state.

As illustrated in FIG. 4, when the lubrication state is normal, lubricating oil 54 fills a space between spindle 52 and main bearing 57, thereby allowing spindle 52 to smoothly rotate. Further, the influence of the temperature of compressor 50, aging degradation of compressor 50, or the like makes the viscosity of lubricating oil 54 lower, which may fail to maintain an oil film between spindle 52 and main bearing 57. In this case, the lubrication state becomes abnormal. When spindle 52 and main bearing 57 are in the abnormal lubrication state, spindle 52 rotates in contact with main bearing 57 as illustrated in FIG. 5, so that main bearing 57 may be damaged.

When spindle 52 continues to rotate in a state where main bearing 57 has been damaged, a degree of the damage to main bearing 57 will become larger. This causes compressor 50 to stop working and, for example, makes the system down (system downtime), leading to a decrease in operation rate of compressor 50.

[About Failure Mode]

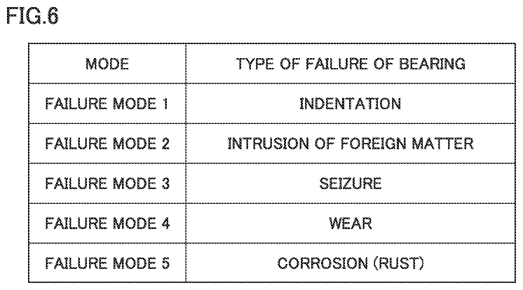

FIG. 6 is a diagram for describing a failure mode. Learning device 100 according to the present embodiment performs the learning processing so as to enable a failure prediction device 400 to be described later to predict the failure mode. Further, the failure mode corresponds to information indicating a type of failure. As illustrated in FIG. 6, examples of a failure of main bearing 57 include failure modes such as an indentation, intrusion of foreign matter, seizure, wear, and corrosion (rust). Each of the failure modes typically corresponds to information indicating a type of failure.

The “indentation” occurs when compressor 50 receives an excessive impact. The “intrusion of foreign matter” occurs when foreign matter is intruded into the space between spindle 52 and main bearing 57. The “seizure” occurs when lubricating oil 54 has run out. As described with reference to FIG. 5, the “wear” occurs when the viscosity of lubricating oil 54 is made lower, and spindle 52 and main bearing 57 come into metal contact with each other. The “corrosion” occurs due to aging of compressor 50. Further, the type of failure is not limited to the examples illustrated in FIG. 6 and may include other failures.

Further, there are a case where one type of the failures described in FIG. 6 occurs and a case where two or more types of the failures occur.

[Frequency Characteristics]

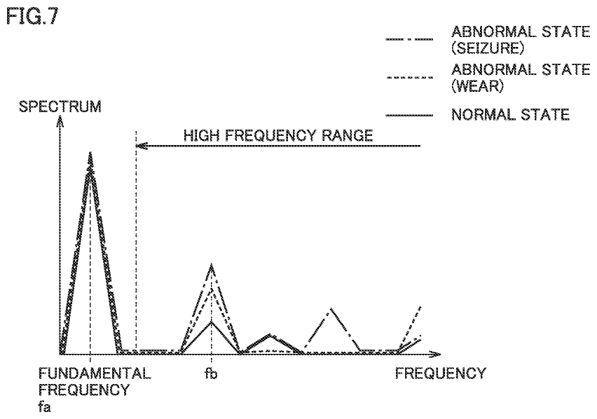

FIG. 7 is a diagram for describing frequency characteristics when the state variable is converted into the frequency domain. FIG. 7 is a diagram for describing frequency characteristics obtained by converting a U-phase current, which is an alternating current among the state variables, into the frequency domain. In FIG. 7, the vertical axis represents a “spectrum”, and the horizontal axis represents a “frequency”. Note that, according to the present embodiment, suppose that the “spectrum” and the “frequency characteristics” have the same meaning. Note that the “spectrum” and the “frequency characteristics” may be different concepts.

In FIG. 7, a solid line indicates a case where main bearing 57 is in the normal state. A dashed line indicates a case where an abnormality occurs in main bearing 57 due to wear (see a failure mode 4 in FIG. 6). A long dashed short dashed line indicates a case where an abnormality occurs in main bearing 57 due to seizure (see a failure mode 2 in FIG. 6).

In the example illustrated in FIG. 7, a spectrum of a fundamental frequency fa is high regardless of whether main bearing 57 is in the normal state or abnormal state. A frequency range higher than fundamental frequency fa is referred to as a high-frequency range. The high-frequency range typically corresponds to a frequency range greater than or equal to three times the fundamental frequency fa.

In the example illustrated in FIG. 7, at a frequency fb that falls within the high-frequency range, a spectrum when an abnormality occurs due to seizure is the highest, a spectrum when an abnormality occurs due to wear is the second highest, and a spectrum when main bearing 57 is normal is the lowest.

As illustrated in FIG. 7, the frequency characteristics (spectrum) differ at a certain frequency (in the example illustrated in FIG. 7, frequency fb) in a manner that depends on the presence or absence of an abnormality in main bearing 57, the type of the abnormality occurring, and the like. Therefore, the presence or absence of an abnormality in main bearing 57, the type of the abnormality occurring, and the like are determined based on the frequency characteristics (spectrum) of the state variable (in the example illustrated in FIG. 7, the alternating current). Note that the abnormal state corresponds to a state leading to a failure, and when the abnormal state continues, it may be defined that compressor 50 results in a failure. Although not specifically illustrated, even when a plurality of types of abnormalities occur in main bearing 57, spectra corresponding to the plurality of types of abnormalities appear at a certain frequency in the high-frequency range.

Next, a description will be given of why the frequency characteristics of the alternating current differ at a certain frequency in a manner that depends on the presence or absence of an abnormality in main bearing 57, the type of the abnormality occurring, and the like. In general, spindle 52 of motor 53 rotates at a high speed, and a frequency component of the alternating current for driving spindle 52 increases accordingly. Therefore, when there is an abnormality in main bearing 57, noise of a high-frequency component tends to occur in the alternating current for driving spindle 52. This causes frequency characteristics of the high-frequency component of the alternating current to differ in a manner that depends on the presence or absence of an abnormality in main bearing 57, the type of the abnormality occurring, and the like. For the same reason, the bus current and the bus voltage as the state variables also differ in frequency characteristics in a manner that depends on the presence or absence of an abnormality in main bearing 57, the type of the abnormality occurring, and the like.

Further, when spindle 52 of motor 53 rotates at a high speed, and particularly an abnormality occurs in main bearing 57, compressor 50 may vibrate greatly. Therefore, when there is an abnormality in main bearing 57, noise of a high-frequency component of the operation state (that is, the refrigerant pressure, the temperature, the humidity, and the refrigerant flow rate) of air-conditioner 200 tends to occur. This also causes the operation state of air-conditioner 200 to differ in frequency characteristics in a manner that depends on the presence or absence of an abnormality in main bearing 57, the type of the abnormality occurring, and the like.

Further, even while compressor 50 is in normal operation, accelerating operation, or decelerating operation, when the state variable is converted into the frequency domain, a reduction in sampling frequency causes the spectrum to differ between when main bearing 57 is in the normal state and when main bearing 57 is in the abnormal state.

[About Training Dataset]

Next, a description will be given of how acquisition unit 118 (see FIG. 1) acquires training dataset 324. According to the present embodiment, acquisition unit 118 itself generates training dataset 324 to acquire training data set 324.

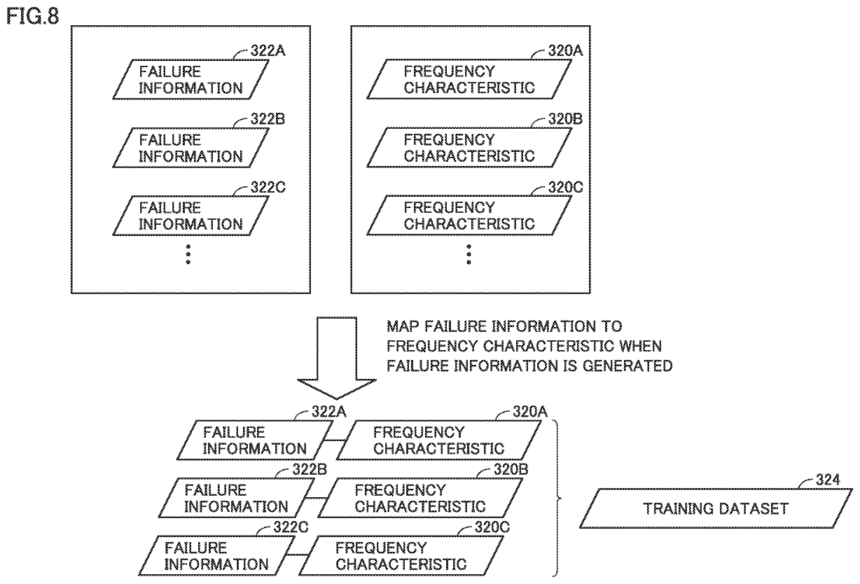

FIG. 8 is a diagram for describing an example of how to generate training dataset 324. Referring to FIG. 8, acquisition unit 118 associates the frequency characteristics obtained as a result of the conversion made by conversion unit 116 with the failure information generated by failure determination unit 112.

FIG. 8 illustrates, as failure information 322, failure information 322A, failure information 322B, and failure information 322C. Further, failure information 322 corresponds to information generated by failure determination unit 112. Failure information 322 corresponds to “model failure information” according to the present disclosure. Failure information 322A, failure information 322B, and failure information 322C also correspond to “model failure information”.

Frequency characteristics generated by conversion unit 116 when failure information 322A is generated by failure determination unit 112 are referred to as frequency characteristics 320A. Frequency characteristics generated by conversion unit 116 when failure information 322B is generated by failure determination unit 112 are referred to as frequency characteristics 320B. Frequency characteristics generated by conversion unit 116 when failure information 322C is generated by failure determination unit 112 are referred to as frequency characteristics 320C.

That is, failure information 322A and frequency characteristics 320A are generated at the same time. Failure information 322B and frequency characteristics 320B are generated at the same time. Failure information 322C and frequency characteristics 320C are generated at the same time.

Acquisition unit 118 labels frequency characteristics 320 with corresponding failure information generated at the same time as frequency characteristics 320 to generate a piece of training data. In other words, acquisition unit 118 associates the failure information with the frequency characteristics generated at the same as the failure information. Since the time at which the failure information is generated and the time at which the frequency characteristics are generated are the same, acquisition unit 118 associates the failure information with the frequency characteristics using the time as a key, for example.

In the example illustrated in FIG. 8, acquisition unit 118 labels frequency characteristics 320A with failure information 322A to generate a piece of training data. Acquisition unit 118 labels frequency characteristics 320B with failure information 322B to generate a piece of training data. Acquisition unit 118 labels frequency characteristics 320C with failure information 322C to generate a piece of training data.

Further, acquisition unit 118 generates a plurality of pieces of training data (in the example illustrated in FIG. 8, three pieces of training data) as a training dataset. Acquisition unit 118 acquires the plurality of pieces of training data thus generated (in the example illustrated in FIG. 8, three pieces of training data) as a training dataset.

[Extraction Unit and Learning Unit]

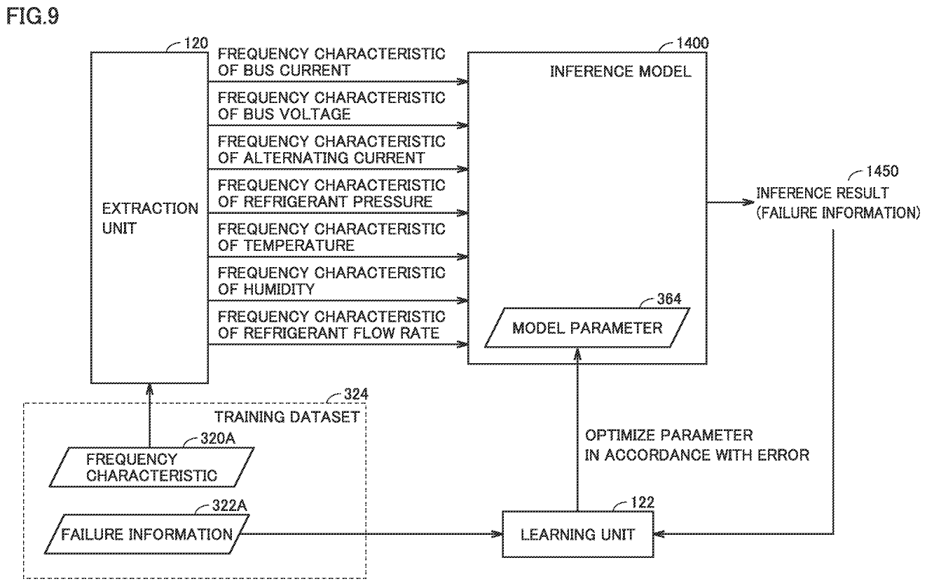

FIG. 9 is a diagram for describing details of processing performed by extraction unit 120 and learning unit 122. In the example illustrated in FIG. 9, an inference model 1400 and a model parameter 364 for defining inference model 1400 are described. Further, according to the present embodiment, learned model 326 (see FIG. 3) defines a network structure and a corresponding parameter (for example, model parameter 364). Inference model 1400 is built based on learned model 326. Note that inference model 1400 and learned model 326 may have the same meaning. Learning processing performed by learning unit 122 according to the present embodiment optimizes model parameter 364 to generate learned model 326. Further, suppose that inference model 1400 is a typical neural network. Model parameter 364 includes a “weight coefficient of the neural network”.

Extraction unit 120 selects a piece of training data from the training dataset. In the example illustrated in FIG. 9, extraction unit 120 selects, as a piece of training data, training data in which frequency characteristics 320A and failure information 322A are associated with each other. Extraction unit 120 extracts seven frequency characteristics from the piece of training data thus selected. In the example illustrated in FIG. 9, the seven frequency characteristics include the frequency characteristic of the bus current, the frequency characteristic of the bus voltage, the frequency characteristic of the alternating current, the frequency characteristic of the refrigerant pressure, the frequency characteristic of the temperature, the frequency characteristic of the humidity, and the frequency characteristic of the refrigerant flow rate.

Extraction unit 120 obtains an inference result 1450 by inputting the seven frequency characteristics thus extracted to inference model 1400. Inference result 1450 corresponds to failure information. Learning unit 122 obtains an error by comparing inference result 1450 output from inference model 1400 with corresponding failure information 322A (true label). Learning unit 122 optimizes (adjusts) a value of model parameter 364 in accordance with the error thus obtained.

In other words, learning unit 122 optimizes inference model 1400 so as to make inference result 1450 output by inputting frequency characteristics 320A extracted from training data (data in which frequency characteristics 320A are labeled with failure information 322A) to inference model 1400 as close as possible to failure information 322A with which the training data is labeled. Furthermore, in other words, learning unit 122 adjusts model parameter 364 so as to cause inference result 1450 obtained by extracting frequency characteristics 320A from the training data and inputting frequency characteristics 320A to inference model 1400 to coincide with failure information 322A associated with frequency characteristics 320A.

Learned model 326 is generated by repeatedly optimizing model parameter 364 of inference model 1400 based on all the pieces of training data included in training dataset 324 in the same procedure.

Learning unit 122 uses any desired optimization algorithm to optimize the value of model parameter 364. Examples of the optimization algorithm include gradient methods such as stochastic gradient descent (SGD), momentum SGD, AdaGrad, RMSprop, AdaDelta, and adaptive moment estimation (Adam).

[Inference Model]

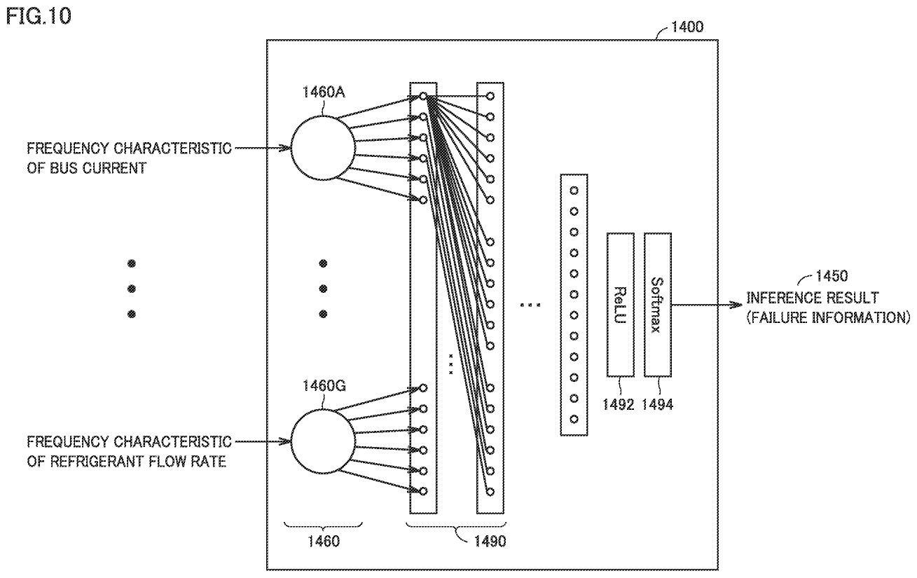

FIG. 10 is a diagram schematically illustrating an example of a network configuration of inference model 1400 illustrated in FIG. 9. Referring to FIG. 10, inference model 1400 includes an input layer 1460, an intermediate layer 1490, an activation function 1492, and a Softmax function 1494. Activation function 1492 and Softmax function 1494 correspond to an output layer. Input layer 1460 includes an input layer 1460A, an input layer 1460B, an input layer 1460C, an input layer 1460D, an input layer 1460E, an input layer 1460F, and an input layer 1460G.

The frequency characteristic of the bus current is input to input layer 1460A as time-series data at predetermined intervals (for example, every 0.1 seconds). The frequency characteristic of the bus voltage is input to input layer 1460B as time-series data at the predetermined intervals. The frequency characteristic of the alternating current is input to input layer 1460C as time-series data at the predetermined intervals. The frequency characteristic of the refrigerant pressure is input to input layer 1460D as time-series data at the predetermined intervals. The frequency characteristic of the temperature of compressor 50 is input to input layer 1460E as time-series data. The frequency characteristic of the humidity of compressor 50 is input to input layer 1460F as time-series data at the predetermined intervals. The frequency characteristic of the refrigerant flow rate is input to input layer 1460G as time-series data at the predetermined intervals. Note that FIG. 10 only illustrates input layer 1460A and input layer 1460G for the sake of simplicity of the drawing.

Intermediate layer 1490 is composed of a fully connected network having a predetermined number of layers, and sequentially connects, for each node, outputs from input layers 1460A to 1460G using a weight and bias determined for each node.

Activation function 1492 such as ReLU is placed on the output side of intermediate layer 1490, and finally, inference result 1450 normalized into a probability distribution by Softmax function 1494 is output. Note that suppose that the number of intermediate layers 1490 is greater than or equal to one.

[Flowchart of Learning Processing]

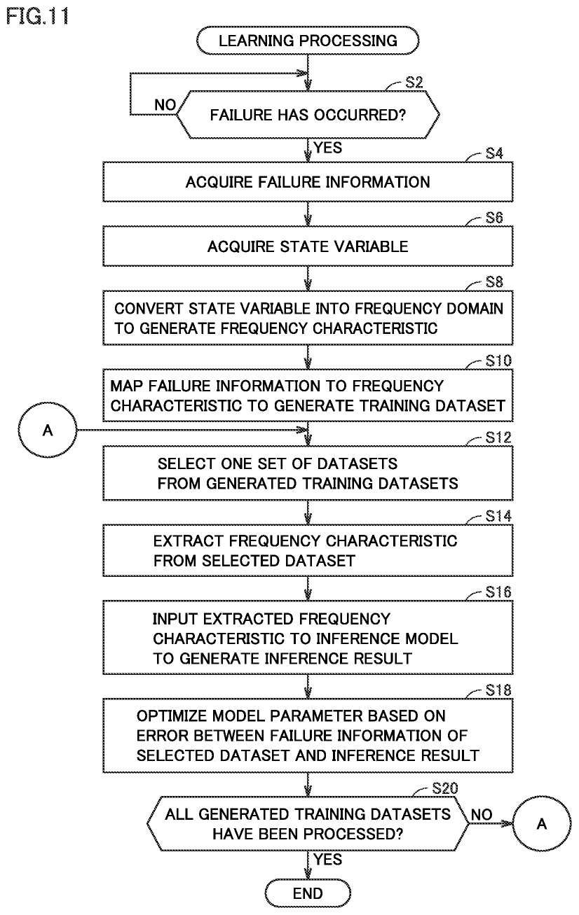

FIG. 11 is an example of a flowchart of learning device 100. In step S2, failure determination unit 112 determines whether a failure has occurred in compressor 50. In step S2, failure determination unit 112 repeatedly execute step S2 until failure determination unit 112 determines that a failure has occurred in compressor 50. When determining that a failure has occurred in compressor 50, failure determination unit 112 generates failure information, and the processing proceeds to step S4.

In step S4, acquisition unit 118 acquires the failure information generated by failure determination unit 112. Next, in step S6, observation unit 114 acquires a state variable. Next, in step S8, conversion unit 116 converts the state variable into the frequency domain to generate frequency characteristics. Next, in step S10, acquisition unit 118 associates the failure information acquired in step S4 with the frequency characteristics generated in step S8 to generate a training dataset (see FIG. 8).

Next, in step S12, extraction unit 120 selects a piece of training data from among a plurality of pieces of training data included in the training dataset. Next, in step S14, extraction unit 120 extracts frequency characteristics from the training data thus selected. Next, in step S16, extraction unit 120 inputs the frequency characteristics thus extracted to inference model 1400 to generate inference result 1450. Next, in step S18, learning unit 122 optimizes model parameter 364 based on an error between the failure information of the dataset selected in step S12 and the inference result generated in step S16. Next, in step S20, learning unit 122 determines whether all the training datasets thus generated have been processed. In step S20, when learning unit 122 determines that not all the generated training datasets have been processed (NO in step S20), the processing returns to step S12. On the other hand, in step S20, when learning unit 122 determines that all the generated training datasets have been processed (YES in step S20), the learning processing brought to an end. Upon the end of the learning processing, learned model 326 is suitably generated by learning device 100.

Learning device 100 according to the present embodiment performs the learning processing based on so-called supervised learning using the failure information generated by failure determination unit 112. Note that, as a modification, learning device 100 may perform the learning processing based on so-called unsupervised learning. The unsupervised learning is a type of learning in which learning device 100 takes a large amount of data that contains only input data (for example, frequency characteristics) to learn how the input data is distributed and performs dimensionality reduction, clustering, rearrangement, and the like on the input data without taking a corresponding dataset. Learning device 100 performs clustering to group features of the training dataset in similar dataset groups. Learning device 100 updates the model parameter of the inference model by assigning the output from the inference model so as to optimize the training dataset based on some criteria provided based on the result of the clustering. Further, as intermediate learning between unsupervised learning and supervised learning, learning device 100 may perform the learning processing based on “semi-supervised learning”. The semi-supervised learning is a type of learning in which learning is performed using one or more pieces of training data composed of some of all the frequency characteristics and failure information associated with the frequency characteristics, and the other of all the frequency characteristics that are not associated with failure information.

### Second Embodiment

[Configuration of Failure Prediction Device]

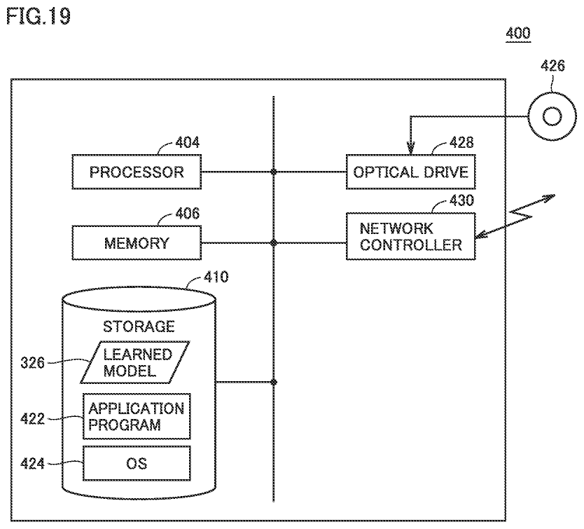

In a second embodiment, a description will be given of a failure prediction device. The failure prediction device predicts a failure of main bearing 57 using learned model 326 generated in the first embodiment. Further, the failure prediction device may acquire learned model 326 from learning device 100 over a network (not illustrated). Further, with the failure prediction device and learning device 100 integrated into a single device, the failure prediction device may acquire learned model 326 generated by learning device 100. Further, the failure prediction device may acquire learned model 326 from an optical disc 426 (see FIG. 19). Further, learned model 326 may be acquired from a device different from learning device 100 (for example, a learning device different from learning device 100). Learned model 326 held by the failure prediction device and learned model 326 most recently generated by learning device 100 are preferably the same.

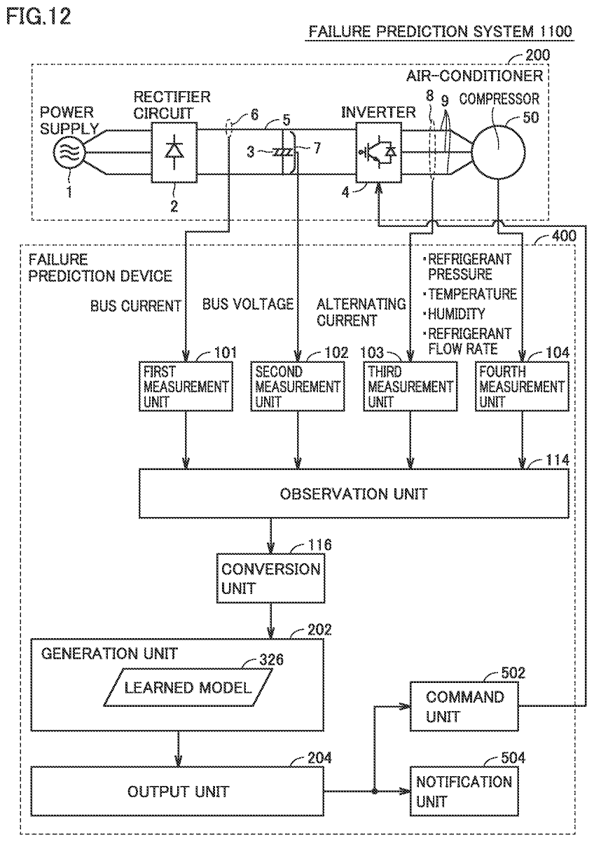

FIG. 12 is a diagram illustrating an example of a configuration of a failure prediction system 1100 according to the present embodiment. Note that, in FIG. 12, components denoted by the same reference numerals as the components illustrated in FIG. 1 have the same capability.

Failure prediction device 400 predicts a failure of main bearing 57 of motor 53 illustrated in FIG. 2. Failure prediction device 400 includes, as function modules, first measurement unit 101, second measurement unit 102, third measurement unit 103, fourth measurement unit 104, observation unit 114, conversion unit 116, a generation unit 202, an output unit 204, a command unit 502, and a notification unit 504.

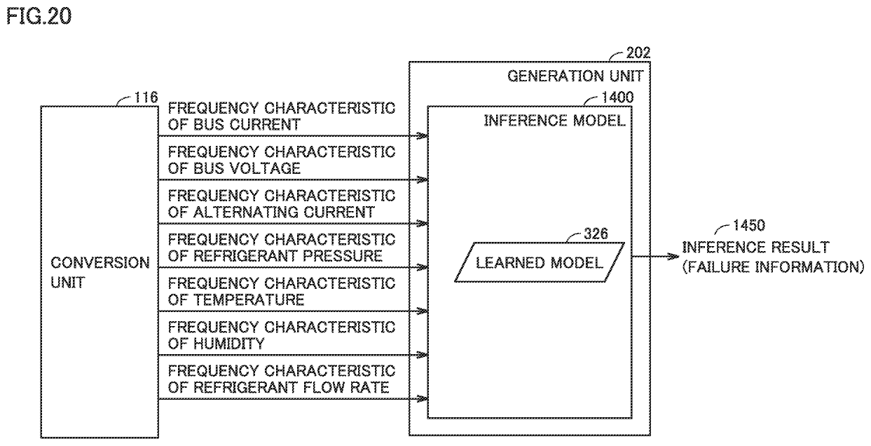

Observation unit 114 acquires the state variable indicating the state of the motor. The state variable is composed of the seven variables described with reference to FIG. 1 and the like. Conversion unit 116 converts each of the seven variables into a frequency domain. Generation unit 202 holds learned model 326. Learned model 326 corresponds to a model generated through the learning processing performed by learning device 100 (see FIG. 11). Generation unit 202 generates failure information on the failure of main bearing 57 using the frequency characteristics and learned model 326. Learned model 326 corresponds to a model representing a relationship between the frequency characteristic obtained by converting the state variable into the frequency domain by conversion unit 116 and the model failure information on the failure of the main bearing. A detailed description of processing performed by generation unit 202 will be given with reference to FIG. 20. Output unit 204 outputs the failure information generated by generation unit 202. In the example illustrated in FIG. 12, the output of output unit 204 is sent to command unit 502 and notification unit 504.

Learned model 326 corresponds to an inference model that outputs, upon receipt of the frequency characteristics obtained by converting the state variable into the frequency domain by conversion unit 116, the failure information as an inference result. As described with reference to FIG. 9 and the like, learned model 326 is generated through the learning processing using the training dataset. The training dataset includes a plurality of pieces of training data in which the frequency characteristics obtained by converting the state variable into the frequency domain by conversion unit 116 are labeled with the model failure information.

Further, command unit 502 transmits a command signal to inverter 4. Notification unit 504 makes a notification based on the failure information.

[About Failure Information]

Next, a description will be given of the failure information generated by generation unit 202. As described in the first embodiment, the failure information corresponds to information indicating at least one of the followings: the presence or absence of a failure of main bearing 57 in compressor 50, the degree of the failure of main bearing 57, and the type of the failure of main bearing 57. According to the present embodiment, suppose that the failure information corresponds to information indicating the degree of the failure of main bearing 57.

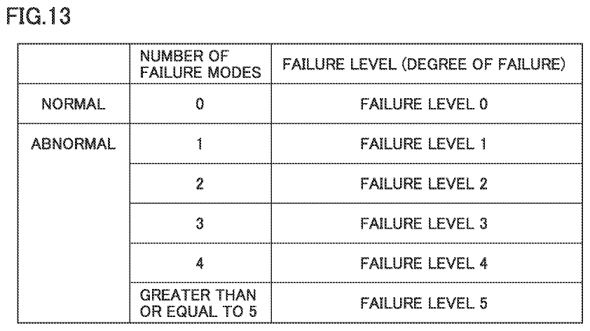

Generation unit 202 holds a first table. Generation unit 202 refers to the first table to identify the failure degree. FIG. 13 is a diagram illustrating an example of the first table. In the example illustrated in FIG. 13, the normal state or the abnormal state is shown in the left column, the number of failure modes is shown in the middle column, and a failure level as a failure degree is shown in the right column. In the example illustrated in FIG. 13, the number of failure modes and the failure degree are associated with each other. The failure mode is as described with reference to FIG. 6.

In the example illustrated in FIG. 13, for example, the number of failure modes of “0” is associated with a failure level 0. Further, the number of failure modes of “0” is defined that main bearing 57 is in the normal state. The number of failure modes of “1” is associated with a failure level 1. The number of failure modes of “2” is associated with a failure level 2. The number of failure modes of “3” is associated with a failure level 3. The number of failure modes of “4” is associated with a failure level 4. The number of failure modes of “greater than or equal to 5” is associated with a failure level 5.

Generation unit 202 acquires the number of failure modes based on learned model 326. Subsequently, generation unit 202 refers to the first table illustrated in FIG. 13 to identify the failure degree (failure level) associated with the number of failure modes. For example, when acquiring “3” as the number of failure modes based on learned model 326, generation unit 202 identifies “3” as the failure level. In this case, generation unit 202 generates failure information indicating “3” as the failure degree. As described above, according to the present embodiment, generation unit 202 identifies an overall failure degree as the failure information.

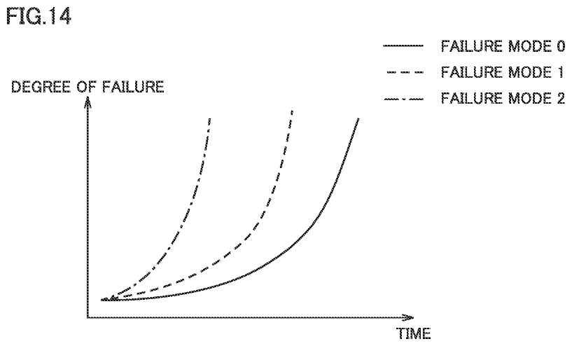

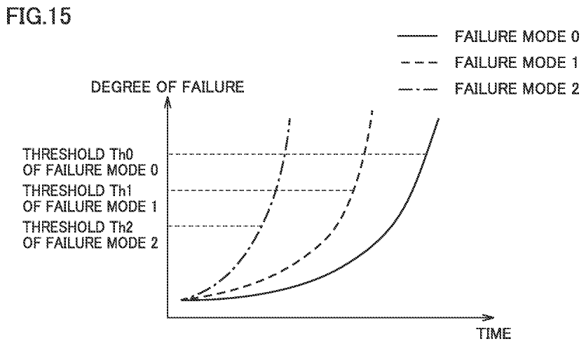

Further, a description will be given of a modification of the failure information. FIG. 14 is a diagram for describing a first modification of the failure information. In the examples illustrated in FIG. 14 and FIG. 15 to be described later, the horizontal axis represents the passage of time, and the vertical axis represents the failure degree. In the examples illustrated in FIG. 14 and FIG. 15 to be described later, a solid line indicates failure mode 0, a dashed line indicates failure mode 1, and a long dashed short dashed line indicates failure mode 2.

Failure mode 0 is a mode in which main bearing 57 has no failure, that is, a mode that corresponds to none of the types of failures of main bearing 57 illustrated in FIG. 6. Further, failure mode 1 and failure mode 2 are as described with reference to FIG. 6. FIG. 14 shows that failure mode 2 is the highest in rate of increase in the failure degree over time. FIG. 14 shows that failure mode 1 is the second highest in rate of increase in the failure degree over time. FIG. 14 shows that failure mode 0 (that is, a mode in which no failure occurs) is the lowest in rate of increase in the failure degree over time. According to the first modification, generation unit 202 may generate failure information indicating the failure degree for each failure mode.

FIG. 15 is a diagram for describing a second modification of the failure information. In the example illustrated in FIG. 15, a threshold is defined for each failure mode. In the example illustrated in FIG. 15, a threshold Th0 is defined as a threshold of failure mode 0. Further, a threshold Th1 is defined as a threshold of failure mode 1. Further, a threshold Th2 is defined as a threshold of failure mode 2. Further, Th0>Th1>Th2 holds.

According to the second modification, when the failure degree for each failure mode is greater than or equal to a threshold of the failure mode, generation unit 202 determines that there is an abnormality under this failure mode. On the other hand, when the failure degree for each failure mode is less than the threshold of the failure mode, generation unit 202 determines that there is no abnormality under this failure mode. For example, when the failure degree of failure mode 1 is greater than or equal to threshold Th1 of failure mode 1, generation unit 202 determines that there is an abnormality under failure mode 1. On the other hand, when the failure degree for each failure mode is less than the threshold of the failure mode, generation unit 202 determines that there is no abnormality under this failure mode. According to the second modification, generation unit 202 generates failure information indicating whether main bearing 57 is in the normal state or abnormal state for each failure mode. Note that, in FIG. 15, threshold Th0 is associated with failure mode 0, but the threshold of failure mode 0 need not be defined.

[Processing Performed by Command Unit]

Next, a description will be given of processing performed by command unit 502 (see FIG. 12). Further, command unit 502 transmits the command signal to inverter 4 to control inverter 4. Inverter 4 performs, for example, pulse width modulation (PWM) control on compressor 50 based on the command signal transmitted from command unit 502. The command signal contains a command value indicating a frequency. Inverter 4 performs PWM control based on the frequency indicated by the command value.

Further, command unit 502 controls the command value indicating the frequency of PWM control in accordance with the failure information output from output unit 204. In the following description, suppose that the failure information is information indicating the degree of the failure of main bearing 57.

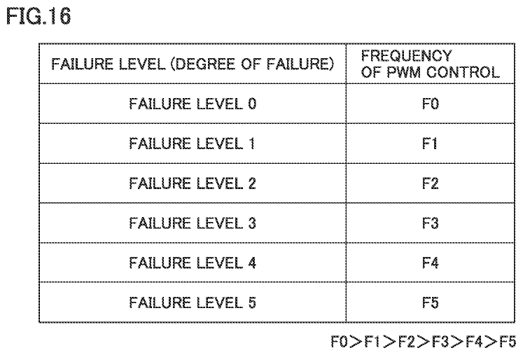

Command unit 502 holds a second table and refers to the second table to determine the command value indicating the frequency of PWM control. FIG. 16 is a diagram illustrating an example of the second table.

In the example illustrated in FIG. 16, as the degree of the failure of main bearing 57, failure levels 0 to 5 (see FIG. 13) are defined. In the example illustrated in FIG. 16, a frequency F of PWM control is associated with each of failure levels 0 to 5. In the example illustrated in FIG. 16, the larger the degree of the failure of main bearing 57, the lower the frequency of PWM control, and the smaller the degree of the failure of main bearing 57, the higher the frequency of PWM control.

In the example illustrated in FIG. 16, failure level 0 is associated with a frequency F0. Further, failure level 1 is associated with a frequency F1. Further, failure level 2 is associated with a frequency F2. Further, failure level 3 is associated with a frequency F3. Further, failure level 4 is associated with a frequency F4. Further, failure level 5 is associated with a frequency F5. For example, F0>F1>F2>F3>F4>F5 holds. Alternatively, when the failure level is greater than or equal to 1, command unit 502 may set frequency F of PWM control to 0 Hz.

Command unit 502 acquires a numerical value (failure level) of the degree of the failure of main bearing 57 indicated by the failure information output from output unit 204. Command unit 502 refers to the second table illustrated in FIG. 16 to identify frequency F associated with the numerical value thus acquired. Command unit 502 transmits, to inverter 4, a command signal containing the command value indicating frequency F thus identified. When the numerical value (failure level) of the degree of the failure of main bearing 57 indicated by the failure information output from output unit 204 is, for example, “2”, command unit 502 identifies frequency F2. Command unit 502 transmits, to inverter 4, a command signal containing the command value indicating frequency F2 thus identified.

[Processing Performed by Notification Unit]

Next, a description will be given of processing performed by notification unit 504 (see FIG. 12). Notification unit 504 makes a notification based on the failure information. For example, notification unit 504 notifies the user of the failure information. How to make a notification of the failure information may be any method as long as the user can know the failure information. For example, notification unit 504 causes a display device (not illustrated) to display the presence or absence of a failure or the failure degree. The display device may be a device provided in failure prediction device 400 or a device provided outside failure prediction device 400. Furthermore, notification unit 504 may notify the user of the failure information by voice. Further, notification unit 504 may notify the user of the failure information by printing and outputting the failure information on paper.

Notification unit 504 may make a notification of a replacement time in accordance with the failure degree indicated by the failure information. Herein, the replacement time may be a replacement time of main bearing 57, a replacement time of compressor 50, or a replacement time of air-conditioner 200.

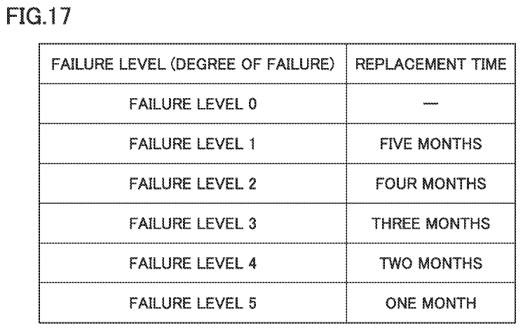

Notification unit 504 holds a third table and refers to the third table to determine the replacement time. FIG. 17 is a diagram illustrating an example of the third table.

In the example illustrated in FIG. 17, failure levels 1 to 5 (see FIG. 13) are defined as the degree of the failure of main bearing 57. In the example illustrated in FIG. 17, the replacement time is associated with each of failure levels 1 to 5. In the example illustrated in FIG. 17, the larger the degree of the failure of the main bearing, the shorter the replacement time, and the smaller the degree of the failure of the main bearing, the longer the replacement time.

In the example illustrated in FIG. 17, failure level 0 is associated with no replacement time. When the failure level is “0”, neither main bearing 57 nor compressor 50 needs to be replaced, so that no replacement time is specified. In the example illustrated in FIG. 17, failure level 1 is associated with “five months” as the replacement time. Further, failure level 2 is associated with “four months” as the replacement time. Further, failure level 3 is associated with “three months” as the replacement time. Further, failure level 4 is associated with “two months” as the replacement time. Further, failure level 5 is associated with “one month” as the replacement time.

Notification unit 504 acquires a numerical value (failure level) of the degree of the failure of main bearing 57 indicated by the failure information output from output unit 204. Notification unit 504 refers to the third table illustrated in FIG. 17 to identify the replacement time associated with the numerical value thus acquired. Notification unit 504 transmits a notification signal indicating the replacement time thus identified to the display device. When the numerical value (failure level) of the degree of the failure of main bearing 57 indicated by the failure information output from output unit 204 is, for example, “3”, notification unit 504 identifies “three months” as the replacement time. Notification unit 504 transmits, to the display device, a notification signal indicating “three months” as the identified replacement time.

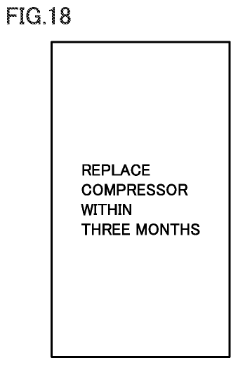

The display device provides a display based on the notification signal thus transmitted. FIG. 18 is a diagram illustrating an example of how the replacement time is displayed. The example illustrated in FIG. 18 is an example of the display of the replacement time (three months) provided by the display device. In the example illustrated in FIG. 18, a sentence “Replace the compressor in three months” is displayed.

[Hardware Configuration of Failure Prediction Device]

FIG. 19 is a diagram illustrating an example of a hardware configuration of failure prediction device 400. Referring to FIG. 19, failure prediction device 400 includes, as core hardware components, a processor 404, a memory 406, an optical drive 428, a network controller 430, and a storage 410.

Processor 404 is a computing entity that executes various programs to perform processing necessary for failure prediction device 400 to work, and processor 404 includes, for example, at least either one or more CPUs or one or more GPUs. At least either a CPU or a GPU, each having a plurality of cores, may be used as processor 404.

Memory 406 provides a storage area for temporarily storing program code, a work memory, or the like when processor 404 executes a program. Examples of memory 406 include a volatile memory device such as a DRAM or an SRAM.

Network controller 430 transmits and receives data to and from any information processing device or the like including a management device 300 over a local network or the like. Network controller 430 may adhere to any communication system such as Ethernet (registered trademark), wireless LAN, and Bluetooth (registered trademark).

Storage 410 stores an OS 424 to be executed by processor 404, an application program 422 for implementing the function of failure prediction device 400 according to the present embodiment, learned model 326, and the like. Examples of storage 410 include a non-volatile memory device such as a hard disk or an SSD.

Optical disc 426 is an example of a non-transitory recording medium and is distributed with any desired program stored in optical disc 426 in a non-volatile manner. Optical drive 428 reads the program from optical disc 426 and installs the program in storage 410, thereby configuring failure prediction device 400 according to the present embodiment. Further, with learned model 326 stored in optical disc 426, failure prediction device 400 may acquire learned model 326 from optical disc 426.

FIG. 19 illustrates an optical recording medium such as optical disc 426 as an example of the non-transitory recording medium, but the non-transitory recording medium is not limited to such an optical recording medium, and a semiconductor recording medium such as a flash memory, a magnetic recording medium such as a hard disk or a storage tape, or a magneto-optical recording medium such as a magneto-optical (MO) disk may be used.

Further, the program for implementing failure prediction device 400 may be distributed not only with the program stored in any desired recording medium as described above but also through download from a server device or the like over the Internet or an intranet.

[Processing Performed by Generation Unit]

FIG. 20 is a diagram for describing processing performed by generation unit 202. The frequency characteristics of the state variable obtained as a result of the conversion made by conversion unit 116 are input to inference model 1400 as time-series data at predetermined intervals (for example, every 0.1 seconds). In the example illustrated in FIG. 20, the frequency characteristics of the state variable include seven frequency characteristics (in the example illustrated in FIG. 20, the frequency characteristic of the bus current, the frequency characteristic of the bus voltage, the frequency characteristic of the alternating current, the frequency characteristic of the refrigerant pressure, the frequency characteristic of the temperature, the frequency characteristic of the humidity, and the frequency characteristic of the refrigerant flow rate).

When the frequency characteristics of the state variable are input to inference model 1400, operation processing defined by inference model 1400 is performed, and failure information is output as inference result 1450. Note that, in FIG. 20, both inference model 1400 and learned model 326 are illustrated for the sake of convenience.

[Flowchart of Failure Prediction Processing]

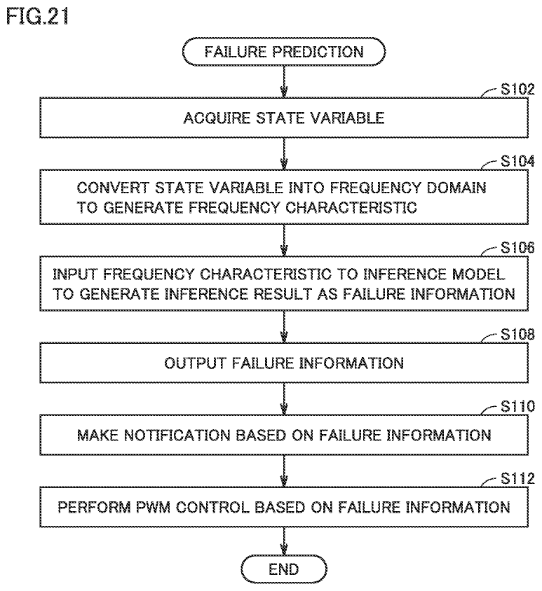

FIG. 21 is an example of a flowchart of failure prediction device 400. Processing illustrated in FIG. 21 is performed at predetermined intervals (for example, every 0.1 seconds). In step S102, observation unit 114 acquires a state variable. Next, in step S104, conversion unit 116 converts the state variable into the frequency domain to generate frequency characteristics. Next, in step S106, generation unit 202 inputs the frequency characteristics to inference model 1400 to generate inference result 1450 as failure information. Next, in step S108, output unit 204 outputs the failure information. Next, in step S110, notification unit 504 makes a notification based on the failure information. Next, in step S112, command unit 502 causes inverter 4 to perform PWM control based on the failure information. Note that failure prediction device 400 may perform step S110 and step S112 at the same time. Further, failure prediction device 400 may perform step S112 before step S110.

[Summary]

Next, a summary of the first embodiment and the second embodiment will be given below.

(1) In general, spindle 52 of motor 53 rotates at a high speed, and a frequency component of an alternating current for driving spindle 52 increases accordingly. Therefore, when there is an abnormality in main bearing 57, noise of a high-frequency component tends to occur when driving spindle 52. In view of this tendency, generation unit 202 of failure prediction device 400 according to the second embodiment generates failure information on the failure of the bearing using the frequency characteristics and inference model 1400. The frequency characteristics correspond to information obtained by converting the state variable into the frequency domain by conversion unit 116. Inference model 1400 represents a relationship between the frequency characteristics of the state variable and model failure information on the failure of main bearing 57. Therefore, for example, when noise of a high-frequency component occurs, generation unit 202 can generate failure information that allows the failure of main bearing 57 to be predicted with high accuracy. Therefore, failure prediction device 400 according to the second embodiment can increase the accuracy in predicting the failure of main bearing 57. As a result, failure prediction device 400 according to the second embodiment can minimize system downtime due to the failure of main bearing 57 and can increase the operation rate of the electrical device (in the above-described embodiment, the air-conditioner) having a bearing mechanism such as compressor 50.

(2) Further, as described with reference to FIG. 9 and the like, inference model 1400 is a model trained by learning device 100. Since inference model 1400 is updated in response to the occurrence of another failure or the like, failure prediction device 400 can generate failure information that allows the failure of main bearing 57 to be predicted with high accuracy.

(3) As described with reference to FIG. 12 and the like, the state variable include the alternating current, the bus voltage, and the bus current. Therefore, failure prediction device 400 can predict a failure based on a variable in which noise of a high-frequency component tends to occur when there is an abnormality in main bearing 57. Therefore, failure prediction device 400 can increase the accuracy in predicting the failure of main bearing 57.

(4) Motor 53 is directly or indirectly connected to inverter 4. Further, as described in FIG. 16 and the like, command unit 502 controls the command value indicating the frequency to be output to inverter 4 in accordance with the failure information. Therefore, failure prediction device 400 can control motor 53 in accordance with the failure information.

(5) As described with reference to FIG. 12 and the like, the state variable includes the operation state (that is, the second state variable) of air-conditioner 200 provided with motor 53. Therefore, failure prediction device 400 can make a prediction reflecting the operation state of air-conditioner 200 about the failure of main bearing 57.

(6) As described with reference to FIG. 12 and the like, the operation state of air-conditioner 200 includes the refrigerant pressure, the temperature, the humidity, and the refrigerant flow rate. Therefore, failure prediction device 400 can predict a failure based on a variable in which noise of a high-frequency component tends to occur when there is an abnormality in main bearing 57. It is therefore possible to increase the accuracy in predicting the failure of main bearing 57.

(7) Further, as described with reference to FIG. 18 and the like, notification unit 504 makes a notification based on the failure information. Therefore, failure prediction device 400 allows the user to recognize that main bearing 57 may fail or that main bearing 57 has failed.

(8) Further, as described with reference to FIG. 18 and the like, notification unit 504 makes a notification of the replacement time in accordance with the failure degree indicated by the failure information. This allows the user to recognize the replacement time of main bearing 57 and the like.

(9) Further, as described with reference to FIG. 15 and the like, notification unit 504 may make a notification of the type of the failure (for example, the failure mode). Therefore, failure prediction device 400 allows the user to recognize the type of the failure of main bearing 57.

(10) As described with reference to FIG. 13 and the like, the failure information may be information indicating at least one of the followings: the presence or absence of the failure of main bearing 57, the degree of the failure of main bearing 57, and the type of the failure of main bearing 57. Therefore, failure prediction device 400 allows the user to recognize at least one of the followings: the presence or absence of the failure of main bearing 57, the degree of the failure of main bearing 57, and the type of the failure of main bearing 57.

(11) In learning device 100 according to the first embodiment, as described with reference to FIG. 8 and the like, acquisition unit 118 acquires a training dataset including the frequency characteristics of the state variable obtained by converting the state variable indicating the state of motor 53 into the frequency domain and a plurality of pieces of training data in which the frequency characteristics are labeled with the failure information on the failure of main bearing 57. Further, as described with reference to FIG. 9 and the like, learning unit 122 optimizes inference model 1400 so as to make an inference result that is output from the inference model by inputting the frequency characteristics extracted from the training dataset to the inference model as close as possible to the failure information with which the training dataset is labeled. Therefore, when there is an abnormality in main bearing 57, learning device 100 can optimize inference model 1400 so as to increase the accuracy in predicting the failure of main bearing 57 by reflecting the tendency that noise of a high-frequency component tends to occur in the alternating current for driving spindle 52.

(12) Further, as described with reference to FIG. 12 and the like, the state variable include the alternating current, the bus voltage, and the bus current. Therefore, learning device 100 can optimize inference model 1400 so as to allow failure prediction device 400 to predict a failure based on a variable in which noise of a high-frequency component tends to occur when there is an abnormality in main bearing 57.

### Third Embodiment

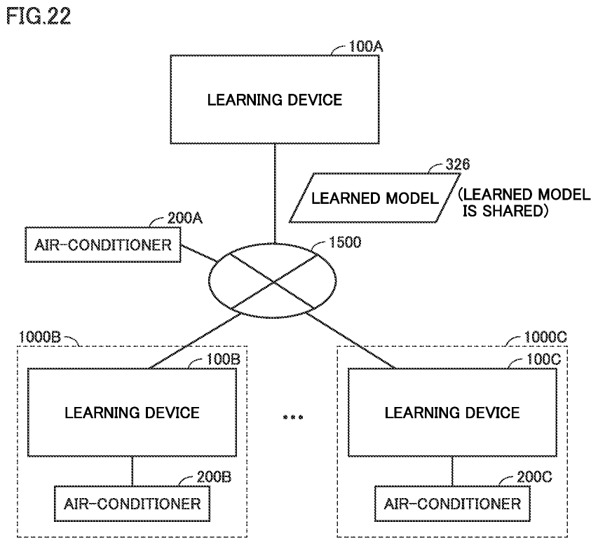

FIG. 22 is a diagram for describing a learning system according to a third embodiment. In the first embodiment, the configuration where air-conditioner 200 and learning device 100 are integrated into a single device has been described. In the third embodiment, however, a description will be given of a configuration where air-conditioner 200 and learning device 100 are not integrated into a single device. Typically, learning device 100 is installed in a cloud server. Referring to FIG. 22, a description will be given below of the learning system according to the third embodiment.

The example illustrated in FIG. 22 includes a learning device 100A, an air-conditioner 200A, a learning system 1000B, a learning system 1000C, and a network 1500. In the example illustrated in FIG. 22, learning device 100A is installed in a cloud server. Learning system 1000B includes a learning device 100B and an air-conditioner 200B. Learning system 1000C includes a learning device 100C and an air-conditioner 200C. Network 1500 is implemented via the Internet, an intranet, or the like. Air-conditioner 200A, learning device 100A, learning system 1000B, and learning system 1000C are installed at separate places (for example, a factory, a house, or the like).

Note that FIG. 22 illustrates an example provided with one learning device 100A and one air-conditioner 200A. However, at least either the number of learning devices 100A or the number of air-conditioners 200A may be greater than or equal to two. Further, the example thus illustrated is provided with two learning systems (learning system 1000B and learning system 1000C). The number of learning systems, however, may be one, or greater than or equal to three.

In the example illustrated in FIG. 22, learning device 100A, learning device 100B, learning device 100C, and air-conditioner 200A are connected to network 1500. Failure determination unit 112 in learning device 100A determines whether a bearing of air-conditioner 200A has failed. Learning device 100A generates, based on the failure information or the like, a training dataset by, for example, the method described with reference to FIG. 8 and the like. Further, learning device 100A generates learned model 326 based on the training dataset thus generated and the like.

Learning device 100A may transmit learned model 326 generated by learning device 100A to the other learning device (learning device 100B and learning device 100C) over network 1500. Upon receipt of learned model 326, the other learning device update a learned model held by the other learning device based on learned model 326.

Further, learning device 100A may receive the learned model updated by the other learning device. Learning device 100A updates the learned model held by learning device 100A based on the learned model received from the other learning device. That is, learning device 100A and the other learning device may share the learned model.

Further, learning device 100A may transmit the training dataset acquired by learning device 100A (for example, the training dataset generated by learning device 100A) to the other learning device (learning device 100B and learning device 100C). Upon receipt of the training dataset, the other learning device updates the learned model held by the other learning device based on the training data thus received.

Further, learning device 100A may receive the training dataset acquired by the other learning device. Learning device 100A updates the learned model held by learning device 100A based on the training dataset received from the other learning device. That is, learning device 100A and the other learning device share the training dataset.

Further, learning device 100A may transmit failure information acquired by failure determination unit 112 of learning device 100A to the other learning device (learning device 100B and learning device 100C). Upon receipt of the failure information, the other learning device updates the learned model held by the other learning device based on the failure information thus received.

Further, learning device 100A may receive the failure information acquired by the other learning device. Learning device 100A updates the learned model held by learning device 100A based on the failure information received from the other learning device. That is, learning device 100A and the other learning device may share the failure information.

Further, learning device 100A may transmit at least two of the followings: the failure information, the training dataset, and learned model 326, to another learning device. Further, learning device 100A may receive at least two of the followings: the failure information, the training dataset, and learned model 326, from the other learning device.

Learning device 100A according to the present embodiment may receive at least one of the followings: the failure information, the training dataset, and learned model 326, from the other learning device. Therefore, learning device 100A according to the present embodiment can increase the amount of information used for updating inference model 1400 as compared with “a learning device that receives none of the followings: the failure information, the training dataset, and learned model 326, from the other learning device”. Therefore, learning device 100A according to the present embodiment can generate a learned model with high accuracy as compared with “a learning device that receives none of the followings: the failure information, the training dataset, and learned model 326, from the other learning device”.

Further, learning device 100A according to the present embodiment may transmit at least two of the followings: the failure information, the training dataset, and learned model 326, to another learning device. Therefore, learning device 100A according to the present embodiment can increase the amount of information used for updating the inference model in the other learning device as compared with “a learning device that transmits none of the followings: the failure information, the training dataset, and learned model 326, to the other learning device”. Therefore, learning device 100A according to the present embodiment can cause the other learning device to generate a learned model with high accuracy as compared with “a learning device that transmits none of the followings: the failure information, the training dataset, and learned model 326, to the other learning device”.

Note that, according to the third embodiment, another learning system may be added later. Further, another air-conditioner may be added later. Further, another learning device may be added later. Further, the other learning system (learning system 1000B or learning system 1000C) may be removed later. Further, the other air conditioner (air-conditioner 200B or air-conditioner 200C) may be removed later. Further, the other learning device (a learning device 400B or a learning device 400C) may be removed later. Further, the learning device (for example, learning device 100A) associated with one air-conditioner (for example, air-conditioner 200A) may update the inference model for the other air-conditioner.

Further, the learning system may include a collection device that collects a learning result (for example, optimized inference model 1400, optimized model parameter 364, or the like) of each of the plurality of learning devices illustrated in FIG. 22. The collection device acquires the learning result and attribute information on compressor 50 that is an acquisition source of the learning result with, for example, the learning result and the attribute information associated with each other. The attribute information on compressor 50 includes, for example, at least one of a model number of the compressor and a specification of the compressor. The collection device updates the learning result based on N (N is an integer of greater than or equal to two) learning results associated with one piece of attribute information (that is, a learning result of each of the N learning devices). The collection device updates the learning result based on, for example, “a combination of failure information and frequency characteristics” included in the N learning results. For example, the collection device generates a new model parameter 364 based on N model parameters 364. The learning result thus updated corresponds to a learning result generated based on the N learning results. Therefore, the updated learning result has higher accuracy in predicting a failure than any of the N learning results. The collection device transmits the updated learning result to all the failure prediction devices having one piece of attribute information associated with the N learning results used to generate the updated learning result. Therefore, all the failure prediction devices can make a prediction about a failure based on the updated learning result (for example, further optimized model parameter 364). That is, all the failure prediction devices can make a prediction about a failure based on the learning result with high accuracy in predicting a failure. This in turn allows an increase in prediction accuracy of the failure prediction device.

### Fourth Embodiment

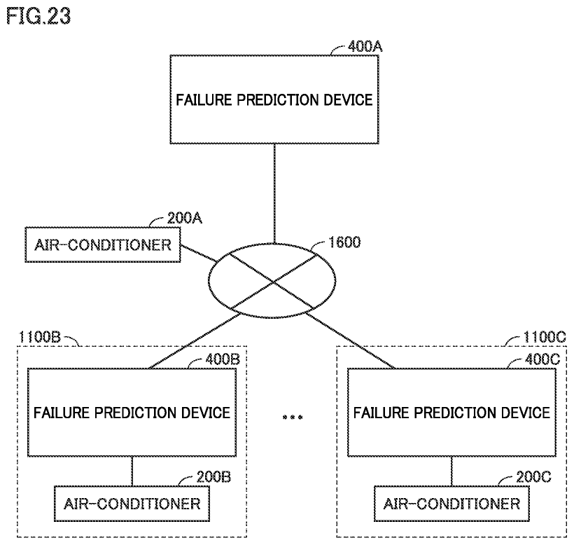

FIG. 23 is a diagram for describing a failure prediction system according to a fourth embodiment. In the second embodiment, the configuration where air-conditioner 200 and failure prediction device 400 are integrated into a single device has been described. In the fourth embodiment, however, a description will be given of a configuration where air-conditioner 200 and failure prediction device 400 are not integrated into a single device. Typically, failure prediction device 400 is installed in a cloud server. Referring to FIG. 23, a description will be given below of the failure prediction system according to the fourth embodiment.

The example illustrated in FIG. 23 includes a failure prediction device 400A, air-conditioner 200A, a failure prediction system 1100B, a failure prediction system 1100C, and a network 1600. Failure prediction system 1100B includes failure prediction device 400B and air-conditioner 200B. Failure prediction system 1100C includes failure prediction device 400C and air-conditioner 200C. Network 1600 is implemented via the Internet, an intranet, or the like. Air-conditioner 200A, failure prediction device 400A, failure prediction system 1100B, and failure prediction system 1100C are installed at separate places (for example, a factory, a house, or the like).

Note that FIG. 23 illustrates an example provided with one failure prediction device 400A and one air-conditioner 200A. However, at least either the number of failure prediction devices 400A or the number of air-conditioners 200A may be greater than or equal to two. Further, the example thus illustrated is provided with two failure prediction systems (failure prediction system 1100B and failure prediction system 1100C). The number of failure prediction systems, however, may be one, or greater than or equal to three.

In the example illustrated in FIG. 23, failure prediction device 400A, failure prediction device 400B, failure prediction device 400C, and air-conditioner 200A are connected to network 1600. Failure prediction device 400A receives failure information generated by generation unit 202 of the other failure prediction device (failure prediction device 400B and failure prediction device 400C). Failure prediction device 400A stores the failure information thus received and identification information (for example, ID: identification) of a sender of the failure information with the failure information and the identification information associated with each other. For example, upon receipt of the failure information from failure prediction device 400B, failure prediction device 400A stores the failure information and the ID of failure prediction device 400B with the failure information and the ID associated with each other. Subsequently, notification unit 504 of failure prediction device 400A make a notification about the air-conditioner (in the example illustrated in FIG. 22, air-conditioner 200B) associated with failure prediction device 400B based on the failure information. For example, notification unit 504 of failure prediction device 400A makes a notification such as a display of an image of “Replace the compressor of air-conditioner 200B in three months” as illustrated in FIG. 18.

Failure prediction device 400A according to the present embodiment can make a notification about the air-conditioner associated with the other failure prediction device based on the failure information. This allows the user of failure prediction device 400A to recognize not only the failure information on air-conditioner 200A associated with failure prediction device 400A but also the failure information on the air-conditioner associated with the other failure prediction device. This in turn allows the user of failure prediction device 400A to make preparations for repair and service parts in a planned manner, minimize system downtime due to the failure of the air-conditioner, and increase the operation rate of the air-conditioner.

Further, failure prediction device 400A may transmit the failure information generated by generation unit 202 of failure prediction device 400A to the other failure prediction device. The other failure prediction device stores the failure information thus received and the identification information on a sender of the failure information (that is, the ID of failure prediction device 400A) with the failure information and the identification information associated with each other. Subsequently, notification unit 504 of the other failure prediction device makes a notification about the air-conditioner associated with failure prediction device 400A (in the example illustrated in FIG. 22, air-conditioner 200A) based on the failure information. For example, notification unit 504 of other failure prediction device 400 makes a notification such as a display of an image of “Replace the compressor of air-conditioner 200A in three months” as illustrated in FIG. 18.

As described above, failure prediction device 400A transmits the failure information on air-conditioner 200A associated with failure prediction device 400A to the other failure prediction device. Therefore, failure prediction device 400A can notify the other failure prediction device of the failure information on air-conditioner 200A. This allows the user of the other failure prediction device to recognize not only the failure information on (air-conditioner 200A) associated with the other failure prediction device but also the failure information on air-conditioner 200A. This in turn allows the user of other failure prediction device 400 to make preparations for repair and service parts in a planned manner, minimize system downtime due to the failure of the air-conditioner, and increase the operation rate of the air-conditioner.

Note that transmitting, by failure prediction device 400A, the failure information to the other failure prediction device and receiving, by failure prediction device 400A, the failure information from the other failure prediction device may be represented as “sharing the failure information between failure prediction device 400A and the other failure prediction device”.

<Modification>

(1) The state variable according to the above-described embodiments has been described as the seven variables of “bus current, bus voltage, alternating current, refrigerant pressure, temperature, humidity, and refrigerant flow rate”. The state variable, however, may be at least one of the seven variables. Further, failure prediction device 400 may use the first state variable but not the second state variable. Further, failure prediction device 400 may use the second state variable but not the first state variable.

Further, when there is an abnormality in main bearing 57, “a variable that is the highest in probability of occurrence of noise” among the seven variables may be the “bus current”. That is, the “bus current” may be regarded as being the highest in accuracy in predicting a failure of main bearing 57 among the seven variables. Therefore, failure prediction device 400 may generate the failure information using the frequency characteristics of the “bus current” but without using the frequency characteristics of the other variables (six variables).

Further, when there is an abnormality in main bearing 57, “a variable that is the second highest in probability of occurrence of noise” among the seven variables may be the “refrigerant pressure”. That is, the “refrigerant pressure” may be regarded as being the second highest in accuracy in predicting a failure of main bearing 57 among the seven variables. Therefore, failure prediction device 400 may generate the failure information using the frequency characteristics of the “bus current” and the frequency characteristics of the “refrigerant pressure” but without using the frequency characteristics of the other variables (five variables). Failure prediction device 400 may use at least one of the five variables in order to increase the accuracy in predicting a failure.

Further, in the above-described embodiments, the first state variable has been described as the bus current, the bus voltage, and the alternating current. The first state variable, however, may be another variable as long as the variable indicates the state of motor 53. The first state variable may include, for example, a value indicating an operation sound of motor 53. The first state variable may include a value indicating motor torque of motor 53. The first state variable may include AC power output to motor 53. Further, the second state variable has been described as the refrigerant pressure, the temperature, the humidity, and the refrigerant flow rate. The second state variable, however, may be another variable as long as the variable indicates the state of air-conditioner 200. The second state variable may include at least one of the followings: an operation sound of compressor 50 itself, an operation sound around compressor 50, an operation sound of air-conditioner 200 itself, and an operation sound around air-conditioner 200. The second state variable may further include, for example, a temperature of refrigerant A (see FIG. 2). The second state variable may further include a temperature in compressor 50. The second state variable may further include humidity in compressor 50. The second state variable may further include a frequency of PWM control controlled by command unit 502.

(2) Failure prediction device 400 has been described as a device configured to perform the failure prediction processing using the learned model trained using artificial intelligence. Failure prediction device 400, however, may perform the failure prediction processing without using artificial intelligence. For example, failure prediction device 400 may perform the failure prediction processing using mapping information in which a frequency and frequency characteristics (that is, a spectrum) are associated with each other as illustrated in FIG. 7. Here, the mapping information is defined for each of the plurality of types of failures. Failure prediction device 400 stores the plurality of types of mapping information. Conversion unit 116 of failure prediction device 400 converts the state variable into the frequency domain to generate the frequency characteristic. Generation unit 202 of failure prediction device 400 performs pattern matching processing based on the frequency characteristics generated by conversion unit 116 and the plurality of types of mapping information to identify the type of failure. For example, generation unit 202 of failure prediction device 400 identifies the type of failure corresponding to mapping information that is the same as the frequency characteristics generated by conversion unit 116 or mapping information closest to the frequency characteristics among the plurality of types of mapping information. Generation unit 202 generates failure information indicating the type of failure thus identified. Even failure prediction device 400 having such a configuration can suitably generate failure information.

(3) Further, learning device 100 or failure prediction device 400 has been described as a device configured to perform processing using the neural network described with reference to FIG. 10 and the like (that is, learning processing or failure prediction processing). Learning device 100 or failure prediction device 400 described above, however, may perform processing using another method. Examples of such a method include deep learning, genetic programming, functional logic programming, support-vector machines, or the like.

(4) In the above-described embodiments, the example where motor 53 and main bearing 57 are mounted on compressor 50 has been described. Motor 53 and main bearing 57, however, may be mounted on the other device. The other device is, for example, an engine of a vehicle.

(5) In the above-described embodiments, the electrical device provided with compressor 50 has been described as air-conditioner 200. Compressor 50, however, may be mounted on the other electrical device. The other electrical device is, for example, a pneumatic tool or a refrigerator.

(6) In the learning system and the failure prediction system described above, a function of one device may be owned by the other device. For example, the configuration where learning device 100 includes failure determination unit 112 described with reference to FIG. 1 and the like has been described. Alternatively, for example, an external device different from learning device 100 may include failure determination unit 112. Further, the configuration where failure prediction device 400 includes command unit 502 and notification unit 504 has been described with reference to FIG. 12. Alternatively, for example, an external device different from learning device 100 may include command unit 502 and notification unit 504.

Further, it should be understood that the embodiments disclosed herein are illustrative in all respects and not restrictive. The scope of the present invention is defined by the claims rather than the above description and is intended to include the claims, equivalents of the claims, and all modifications within the scope. Further, the inventions described in the embodiments and each modification are intended to be practiced individually or in combination with each other as circumstances permit.

1. A failure prediction device to predict a failure of a bearing of a motor mounted on an electrical device, the failure prediction device comprising:
a variable acquisition unit to acquire a state variable that is at least one of a first state variable indicating a state of the motor and a second state variable indicating a state of the electrical device;
a conversion unit to convert the state variable into a frequency domain;
a generation unit to generate failure information of the bearing based on a failure mode of the bearing, the failure mode being identified by using frequency characteristics of the state variable obtained by converting the state variable into the frequency domain by the conversion unit and a model representing a relationship between the frequency characteristics of the state variable and model failure information on the failure mode of the bearing; and
an output unit to output the failure information generated by the generation unit.

2-15. (canceled)

16. The failure prediction device according to claim 1, wherein
the generation unit identifies a number of the failure modes and generates the failure information based on the number of the failure modes.

17. The failure prediction device according to claim 1, wherein
the model is an inference model that outputs, upon receipt of the frequency characteristics of the state variable obtained by converting the state variable into the frequency domain by the conversion unit, the failure information as an inference result,
the inference model is generated through learning processing using a training dataset, and
the training dataset includes a plurality of pieces of training data in which the frequency characteristics of the state variable obtained by converting the state variable into the frequency domain by the conversion unit are labeled with the model failure information.

18. The failure prediction device according to claim 1, wherein
the motor is mounted on a compressor,
the compressor is connected to an inverter,
the inverter outputs AC power to the compressor over a bus, and
the first state variable includes at least one of an alternating current flowing through the motor, a voltage of the bus, a current flowing through the bus, a drive sound of the motor, torque of the motor, and the AC power.

19. The failure prediction device according to claim 18, further comprising a command unit to control a command value of a frequency to be output to the inverter in accordance with the failure information.

20. The failure prediction device according to claim 18, wherein
the electrical device is an air-conditioner including the compressor, and
the second state variable includes an operation state of the air-conditioner.

21. The failure prediction device according to claim 1, wherein
the electrical device is an air-conditioner including a compressor, and
the second state variable includes an operation state of the air-conditioner.

22. The failure prediction device according to claim 20, wherein the operation state of the air-conditioner includes at least one of pressure of a refrigerant flowing in the compressor, a flow rate of the refrigerant, a temperature around the compressor, an operation sound around the compressor, and humidity around the compressor.

23. The failure prediction device according to claims 1, further comprising a notification unit to make a notification based on the failure information.

24. The failure prediction device according to claim 23, wherein
the notification unit makes a notification about a replacement time based on a degree of a failure indicated by the failure information.

25. The failure prediction device according to claim 23, wherein
the generation unit generates the failure information that allows a type of the failure mode of the bearing to be identified by identifying the type of the failure mode based on the frequency characteristics of the state variable obtained by converting the state variable into the frequency domain by the conversion unit, and
the notification unit makes a notification about the type of the failure mode.

26. The failure prediction device according to claim 1, wherein the failure information is information indicating at least one of presence or absence of a failure mode of the bearing, a degree of the failure of the bearing, and a type of the failure mode of the bearing.

27. A learning device for optimizing an inference model to be used for predicting a failure of a bearing of a motor mounted on an electrical device, the learning device comprising:
a data acquisition unit to acquire a training dataset including frequency characteristics of a state variable obtained by converting the state variable into a frequency domain, the state variable being at least one of a first state variable indicating a state of the motor and a second state variable indicating a state of the electrical device, and a plurality of pieces of training data in which the frequency characteristics are labeled with failure information on a failure of the bearing;
an extraction unit to extract the frequency characteristics from the training dataset; and
a learning unit to optimize the inference model so as to make an inference result that is output from the inference model by inputting the frequency characteristics extracted from the training dataset to the inference model close to the failure information with which the training dataset is labeled, wherein
the inference model optimized by the learning unit is used in a failure prediction device that identifies a failure mode of the bearing and generates failure information of the bearing based on the failure mode.

28. The learning device according to claim 27, wherein
the motor is mounted on a compressor,
the compressor receives AC power output from an inverter via a bus, and
the first state variable includes at least one of an alternating current flowing through the motor, a voltage of the bus, a current flowing through the bus, a drive sound of the motor, torque of the motor, and the AC power.

29. The learning device according to claim 27, wherein the learning device transmits, to another learning device, at least one of the failure information, the training dataset, and the inference model optimized, and receives, from the other learning device, at least one of the failure information, the training dataset, and the inference model optimized.

30. A learning method for optimizing an inference model to be used for predicting a failure of a bearing of a motor mounted on an electrical device, the learning method comprising
acquiring a training dataset including frequency characteristics of a state variable obtained by converting the state variable into a frequency domain, the state variable being at least one of a first state variable indicating a state of the motor and a second state variable indicating a state of the electrical device, and a plurality of pieces of training data in which the frequency characteristics are labeled with failure information on a failure of the bearing;
extracting the frequency characteristics from the training dataset; and
optimizing the inference model so as to make an inference result that is output from the inference model by inputting the frequency characteristics extracted from the training dataset to the inference model as close as possible to the failure information with which the training dataset is labeled, wherein
the optimized inference model is used in a failure prediction device that identifies a failure mode of the bearing and generates failure information of the bearing based on the failure mode.

31. The failure prediction device according to claim 16, wherein
the model is an inference model that outputs, upon receipt of the frequency characteristics of the state variable obtained by converting the state variable into the frequency domain by the conversion unit, the failure information as an inference result,
the inference model is generated through learning processing using a training dataset, and
the training dataset includes a plurality of pieces of training data in which the frequency characteristics of the state variable obtained by converting he state variable into the frequency domain by the conversion unit are labeled with the model failure information.

32. The failure prediction device according to claim 16, wherein
the motor is mounted on a compressor,
the compressor is connected to an inverter,
the inverter outputs AC power to the compressor over a bus, and
the first state variable includes at least one of an alternating current flowing through the motor, a voltage of the bus, a current flowing through the bus, a drive sound of the motor, torque of the motor, and the AC power.

33. The failure prediction device according to claim 17, wherein
the motor is mounted on a compressor,
the compressor is connected to an inverter,
the inverter outputs AC power to the compressor over a bus, and
the first state variable includes at least one of an alternating current flowing through the motor, a voltage of the bus, a current flowing through the bus, a drive sound of the motor, torque of the motor, and the AC power.

34. The failure prediction device according to claim 18, wherein
the electrical device is an air-conditioner including the compressor, and
the second state variable includes an operation state of the air-conditioner.
